(19) United States
(12) Patent Application Publication
(10) Pub. No.: US 2011/0236571 A1
(43) Pub. Date: Sep. 29, 2011

(54) METHOD OF MANUFACTURING AN OPTICAL MATRIX DEVICE

(76) Inventor: Susumu Adachi, Osaka (JP)

(21) Appl. No.: 13/132,098

(22) PCT Filed: Dec. 2, 2008
(86) PCT No.: PCT/JP2008/071884

§ 371 Date: Jun. 1, 2011

(51) Int. Cl. B05D 5/06

(52) U.S. Cl. 427/162

(57) ABSTRACT

According to the method of manufacturing an optical matrix device of this invention, lyophobic portions which are lyophobic, and lyophilic portions which are lyophilic, with respect to metal ink are formed alternately and parallel, and with a pitch smaller than a width of droplets applied by printing technique, on a foundation of wires to be formed on a substrate. Thus, the ejected droplets extend along edges of the lyophobic portions, while straddling the plurality of lyophobic portions, thereby to improve the accuracy of wire formation. This can form a uniform wire width, and eliminate a possibility of a formed wire making a short circuit with an adjacent wire.

### TECHNICAL FIELD

This invention relates to a method of manufacturing an optical matrix device having a structure of pixels formed of display elements or light receiving elements and arranged in a two-dimensional matrix form, such as a thin imaging device used as a television or a monitor of a personal computer, or a radiation detector provided for a radiographic apparatus used in the medical field, industrial field, or the like.

### BACKGROUND ART

An optical matrix device with a two-dimensional matrix arrangement of elements relating to light and having active elements and capacitors formed of thin-film transistors (TFTs) or the like is in wide use today. Light receiving elements and display elements may be cited as examples of the elements relating to light. This optical matrix device is divided roughly into a device formed of light receiving elements, and a device formed of display elements. The device formed of light receiving elements includes an optical image sensor, and a radiation image sensor used in the medical field, industrial field or the like. The device formed of display elements includes an image display used as a television or a monitor of a personal computer, such as the liquid crystal type having elements which adjust the intensity of transmitted light and the EL type having light emitting elements. Light here refers to infrared light, visible light, ultraviolet light, radiation (X-rays, gamma rays) and so on.

In recent years, a method of using the inkjet technique has been studied vigorously as a method of forming wires of an active matrix substrate provided for such an optical matrix device. This is because it is very useful in that, unlike the conventional photolithographic technique, it can carry out local printing and formation in forming gate wires and data wires of the active matrix substrate, and semiconductors such as gate channels.

By carrying out printing and coating of droplets (ink) containing semiconductor, insulator or conductive particles on an insulating substrate using the inkjet printing technique, semiconductor film, insulator film or conducting wires can be formed. Droplets ejected from an ink jet nozzle are maintained as a solution or in a colloidal state by dissolving or dispersing either of the semiconductor, insulator or conductive particles in an organic solvent. And after printing and coating these droplets on the insulating substrate, the organic solvent is volatized by heating treatment to forms semiconductor film, insulator film or conducting wires (wiring).

In device formation by the inkjet technique, it is important how control should be effected of spreading and bleeding of the droplets which are a fluid ejected onto the substrate. A droplet 50 in a state of droplet width d1 immediately after instillment as shown in FIGS. 32 and 33 undergoes a change in shape with the passage of time to become a droplet 51 which is lower in droplet height and is spread out as shown in FIGS. 34 and 35. For example, the width d1 of droplet 50 which was 50 μm immediately after landing on the substrate can spread up to 100 μm (d2) with the passage of time. This is due also to wettability of the droplet and substrate.

This spreading of the droplets has given rise to a problem that a formed wire contacts another wire to make a short circuit. In order to solve this problem, Patent Document 1, for example, discloses a method of performing pretreatment for shaping the boundary of the fluid discharged along the boundary of a wiring pattern area. Specifically, banks are formed along the boundary of the wiring pattern area to guide spreading of droplets in directions along the banks.
[Patent Document 1]
Japanese Patent No. 4003273

### DISCLOSURE OF THE INVENTION

### Problem to be Solved by the Invention

However, since most patterns formed on the active matrix substrate are elongated wires, it is a very laborious operation to form a bank at the boundary of a wiring pattern for each wire. Further, since a bank forming pattern is different for each different wiring pattern, the bank forming pattern must be changed in accordance with each wiring pattern. It has been impossible to form beforehand a bank forming pattern which can cope with various wiring patterns.

This invention has been made having regard to the state of the art noted above, and its object is to provide a method of manufacturing an optical matrix device having a foundation pattern for guiding in a given direction spreading of a fluid applied by printing technique.

### Means for Solving the Problem

To fulfill the above object, this invention provides the following construction.

In a method of manufacturing an optical matrix device for manufacturing, by a printing technique of applying a fluid, the optical matrix device constructed with elements relating to light arranged in a two-dimensional matrix form, the method of this invention comprises a first insulating film forming step for forming a first insulating film on a surface of a substrate of the optical matrix device; a first foundation pattern forming step for forming a first foundation pattern with lyophilic portions and lyophobic portions formed substantially parallel thereon, by treating part of a surface of the first insulating film to be lyophobic with respect to the fluid; and a first wire forming step for forming wires by applying the fluid to be substantially parallel to a direction of long sides of the lyophobic portions on the first foundation pattern, and to straddle a plurality of the lyophobic portions.

According to the method of manufacturing an optical matrix device of this invention, part of the surface of the insulating film is treated to be lyophobic with respect to the fluid, to form a foundation pattern with lyophilic portions and lyophobic portions formed substantially parallel on the surface of the insulating film. Thus, the fluid applied by printing technique extends on the surfaces of the lyophilic portions along the direction of long sides of the lyophobic portions, and extends also on the surfaces of the lyophobic portions, with extension in directions of the short sides of the lyophobic portions restricted. Wires are formed substantially parallel to the direction of frie long sides of the lyophobic portions on such foundation pattern. Since the direction of wire formation is the same as the direction of extension of the fluid, a uniform wire width can be formed. Since sideways flows of the fluid are restricted, there occurs no short circuit due to contact between adjacent wiring patterns.

It is preferred that a pitch distance provided by adjacent ones of the lyophobic portions and the lyophilic portions is one tenth or less of a width of the fluid applied in the first wiring step. Since extension in the directions of the short sides of the lyophobic portions is restricted, even if the formation position of the fluid applied by the printing technique shifts, shifting in the width direction of the fluid is inhibited. Further, since the pitch distance between adjacent ones of the lyophobic portions and lyophilic portions is one tenth or less of the width of the fluid, wires can be formed in any positions on the foundation pattern as long as they follow in the direction of the long sides of the lyophobic portions.

A nano imprint technique may be used in mask formation for lyophobizing treatment of the insulating film. This can form a minute pitch distance between the lyophobic portions and lyophilic portions, and form masks by repeated transfer. Fluorine plasma may be cited as a specific example of lyophobizing treatment of the insulating film.

An entire surface of the insulating film may be treated to be lyophilic before the lyophobizing treatment of the insulating film. Then, the difference in lyophilic property with respect to the fluid between the lyophilic portions and lyophobic portions is made prominent, whereby the fluid can extend more in the direction of the long sides of the lyophobic portions.

On the surface of the insulating film with the wires and foundation pattern formed by the above method of manufacturing an optical matrix device, an insulating film and wires with another foundation pattern may be further formed. The foundation pattern and wires formed earlier, and the foundation pattern and wires formed later, can form a foundation pattern and a wiring pattern intersecting across the insulating film formed later.

It is preferred that the lyophobic portions are formed to have long sides and short sides in a ratio of 5:1 or more. This allows the applied fluid to extend easily in the direction of the long sides of the lyophobic portions. Also where the lyophobic portions are formed in a staggered arrangement, the fluid will extend in directions along the direction of the long sides of the lyophobic portions, with extension in the directions of the short sides of the lyophobic portions is restricted.

The wires formed in the first wire forming step and the second wire forming step may be formed by inkjet technique. This can print and form the wires locally.

A method of manufacturing an optical matrix device in a second embodiment of this invention is a method of manufacturing, by a printing technique of applying a fluid, an optical matrix device constructed with elements relating to light arranged in a two-dimensional matrix form, the method comprising a first insulating film forming step for forming a first insulating film on a surface of a substrate of the optical matrix device; a first foundation layer forming step for forming a first foundation layer with lyophilic portions and lyophobic portions formed substantially parallel thereon, by treating part of a surface of the first insulating film to be lyophilic with respect to the fluid; and a first wire forming step for forming wires by applying the fluid to be substantially parallel to a direction of long sides of the lyophobic portions on the foundation layer, and to straddle a plurality of the lyophobic portions.

According to the second embodiment of this invention, part of the surface of the insulating film is treated to be lyophilic with respect to the fluid, to form a foundation pattern with lyophilic portions and lyophobic portions formed substantially parallel. Thus, the fluid applied by printing technique extends on the surfaces of the lyophilic portions along the direction of long sides of the lyophobic portions, and extends also on the surfaces of the lyophobic portions, with extension in directions of the short sides of the lyophobic portions restricted. Wires are formed substantially parallel to the direction of the long sides of the lyophobic portions on such foundation pattern. Since the direction of wire formation is the same as the direction of extension of the fluid, a uniform wire width can be formed. Since sideways flows of the fluid are restricted, there occurs no short circuit due to contact between adjacent wiring patterns.

The above method of manufacturing an optical matrix device can manufacture a photodetector, radiation detector or image display device with improved refresh rate.

### Effects of the Invention

The method of manufacturing an optical matrix device, according to this invention, can provide a method of manufacturing an optical matrix device having a foundation pattern for guiding in given directions spreading of a fluid applied by printing technique.

### BRIEF DESCRIPTION OF THE DRAWINGS

FIG. 1 is a flow chart showing a flow of forming a foundation layer on a substrate of a flat panel X-ray detector (FPD) according to Embodiment 1;

FIG. 2 is a view in vertical section showing a process of manufacturing the foundation layer of the FPD according to Embodiment 1;

FIG. 3 is a view in vertical section showing the process of manufacturing the foundation layer of the FPD according to Embodiment 1;

FIG. 4 is an outline perspective view of a mold used in the process of manufacturing the foundation layer of the FPD according to Embodiment 1;

FIG. 5 is a view in vertical section showing the process of manufacturing the foundation layer of the FPD according to Embodiment 1;

FIG. 6 is a view in vertical section showing the process of manufacturing the foundation layer of the FPD according to Embodiment 1;

FIG. 7 is a view in vertical section showing the process of manufacturing the foundation layer of the FPD according to Embodiment 1;

FIG. 8 is a view in vertical section showing the process of manufacturing the foundation layer of the FPD according to Embodiment 1;

FIG. 9 is a view in vertical section showing the process of manufacturing the foundation layer of the FPD according to Embodiment 1;

FIG. 10 is a front view showing the foundation layer of the FPD according to Embodiment 1;

FIG. 11 is a flow chart showing a flow of a process of manufacturing the FPD according to Embodiment 1;

FIG. 12 is a view in vertical section showing a droplet ejected by inkjet technique onto the foundation layer of the FPD according to Embodiment 1;

FIG. 13 is a front view showing the droplet ejected by inkjet technique onto the foundation layer of the FPD according to Embodiment 1;

FIG. 14 is a front view showing the process of manufacturing the FPD according to Embodiment 1;

FIG. 15 is a view in vertical section showing the process of manufacturing the FPD according to Embodiment 1;

FIG. 16 is a front view showing the process of manufacturing the FPD according to Embodiment 1;

FIG. 17 is a view in vertical section showing the process of manufacturing the FPD according to Embodiment 1;

FIG. 18 is a front view showing the process of manufacturing the FPD according to Embodiment 1;

FIG. 19 is a front view showing the process of manufacturing the FPD according to Embodiment 1;

FIG. 20 is a view in vertical section showing the process of manufacturing the FPD according to Embodiment 1;

FIG. 21 is a front view showing the process of manufacturing the FPD according to Embodiment 1;

FIG. 22 is a view in vertical section showing the process of manufacturing the FPD according to Embodiment 1;

FIG. 23 is a view in vertical section showing the process of manufacturing the FPD according to Embodiment 1;

FIG. 24 is a view in vertical section showing the process of manufacturing the FPD according to Embodiment 1;

FIG. 25 is a view in vertical section showing the process of manufacturing the FPD according to Embodiment 1;

FIG. 26 is a view in vertical section showing the process of manufacturing the FPD according to Embodiment 1;

FIG. 27 is a view in vertical section showing the process of manufacturing the FPD according to Embodiment 1;

FIG. 28 is a circuit diagram showing a construction of an active matrix substrate and adjacent circuits provided for the FPD according to Embodiment 1;

FIG. 29 is a front view showing droplets ejected by inkjet technique onto the foundation layer of the FPD according to Embodiment 1;

FIG. 30 is an outline perspective view showing an image display device having an active matrix substrate prepared by a method according to Embodiment 3;

FIG. 31 is a front view showing a foundation layer of an FPD according to a different embodiment of this invention;

FIG. 32 is an explanatory view showing a shape of a droplet ejected by inkjet technique;

FIG. 33 is an explanatory view showing the shape of the droplet ejected by inkjet technique;

FIG. 34 is an explanatory view showing a change in the shape occurring with the passage of time of the droplet ejected by inkjet technique; and

FIG. 35 is an explanatory view showing the change in the shape occurring with the passage of time of the droplet ejected by inkjet technique.

### DESCRIPTION OF REFERENCES

1 . . . substrate
2 . . . insulating film
3 . . . resist film
6 . . . lyophobic portions
7 . . . lyophilic portions
8 . . . foundation layer
9 . . . droplets
10 . . . gate lines
11 . . . ground lines
12 . . . foundation layer
15 . . . data lines
28 . . . flat panel X-ray detector (FPD)
DU . . . X-ray detecting elements
Wp . . . pitch distance
Wd . . . droplet width

### Embodiment 1

<Flat Panel X-ray Detector Manufacturing Method>

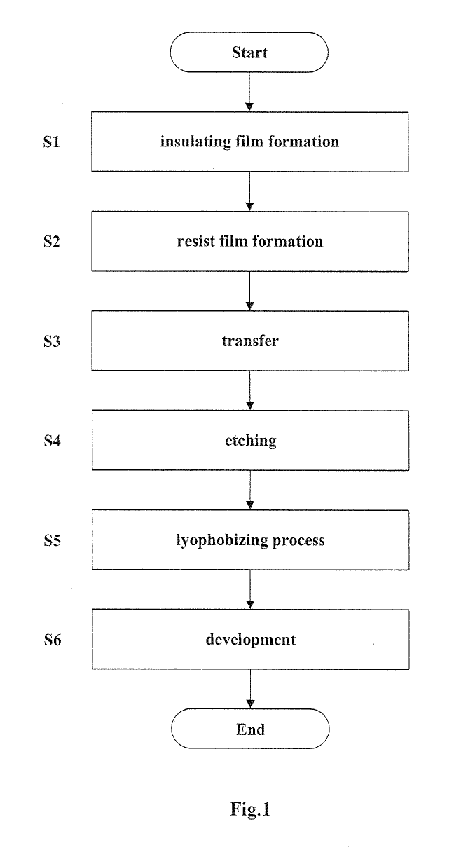

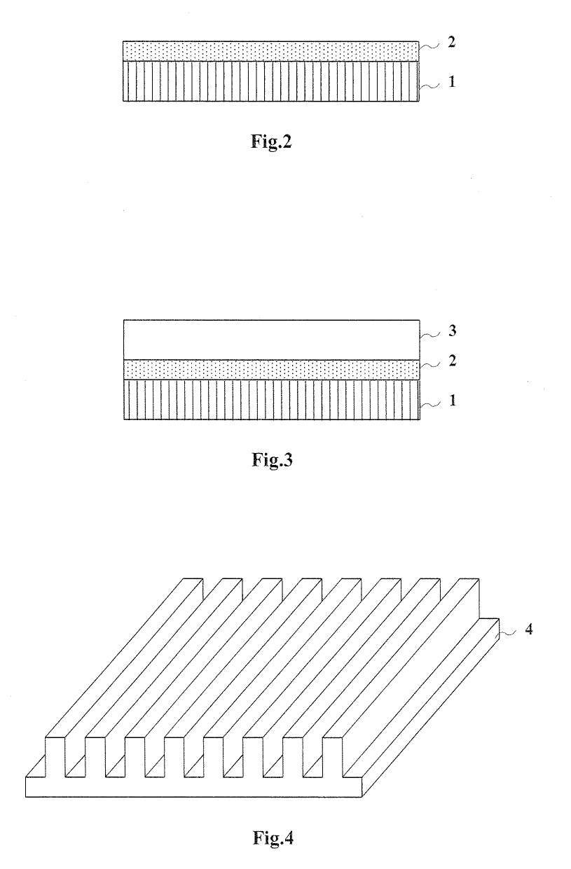

A method of manufacturing a flat panel X-ray detector (hereinafter called FPD) as an example of optical matrix device of this invention will be described hereinafter with reference to the drawings. FIG. 1 is a flow chart of forming a foundation layer on a substrate of the FPD according to Embodiment 1. FIGS. 2 through 9 are views in vertical section showing a process of manufacturing the foundation layer of the FPD according to Embodiment 1. FIG. 10 is a front view of the foundation layer of the FPD according to Embodiment 1.

The process of manufacturing the FPD in Embodiment 1 is divided roughly into two processes. One is a process of forming the foundation layer on a surface of which wires and the like are is to be formed, and the other is a process of forming an active matrix substrate, a radiation conversion layer and so on. Step S1 to step S6 shown in FIG. 1 constitute the process of forming the foundation layer. The process of forming the foundation layer will be described first.

(Step S1) Insulating Film Formation

As shown in FIG. 2, an insulating film 2 is formed on a surface of a substrate 1.

The substrate 1 may be any one of glass, a synthetic resin and a metal. In the case of the synthetic resin, while polyimide, polyethylenenaphthalate (PEN), polyether sulfone (PES) and polyethylene terephthalate (PET) are cited as examples, what is preferred is polyimide which is excellent in heat resistance. When a metal is employed, the substrate 1 can be used also as ground line to be described hereinafter.

The insulating film 2, preferably, is formed of an organic material, and an epoxy resin, acrylic resin and polyimide may be cited. It is preferable to employ a synthetic resin which has lyophilic properties with respect to droplets 9 applied at a time of wire formation. When a lyophobic synthetic resin is employed as the insulating film 2, a lyophilizing process may be carried out for the entire surface of the insulating film 2 to have improved wettability. This insulating film 2 is formed uniformly on a surface of the substrate 1 by spin coat technique, for example. The insulating film 2 corresponds to the first insulating film in this invention. Step S1 corresponds to the first insulating film forming step in this invention.

(Step S2) Resist Film Formation

As shown in FIG. 3, a resist film 3 is further formed on a surface of the insulating film 2. The resist film 3 has thermoplastic properties. As the thermoplastic resist film 3, polymethyl methacrylate (PMMA) and polycarbonate (PC) are preferred, for example. An ultraviolet curable resist film 3 may be employed instead of the thermoplastic resist film 3. As the ultraviolet curable resist film 3, Resin PAK-01, 02 for UV nano imprints manufactured by Toyo Gosei Co., Ltd. are cited, for example. This resist film 3 is formed on a surface of the insulating film 2 by spin coat technique, for example.

(Step S3) Transfer

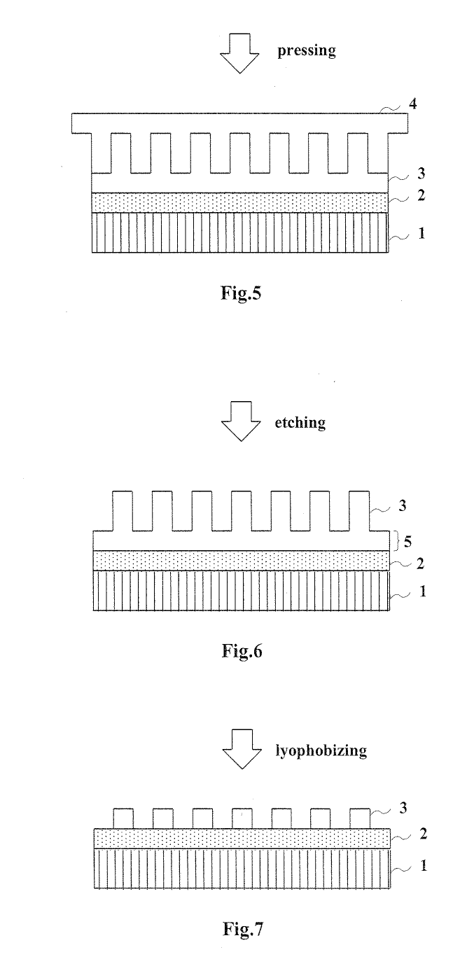

Ridges and grooves are formed on the resist film 3 using a transfer technique. In this application, a nano imprint technique is employed as the transfer technique. A mold 4 with a shape of ridges and grooves formed alternately and linearly beforehand as shown in FIG. 4 is inverted and pressed on the resist film 3 as shown in FIG. 5, whereby ridges and grooves can be formed on the resist film 3. The pitch of these ridges and grooves may be at regular intervals, and a preferred pitch width is one tenth or less of the width of droplets ejected when forming wires in a subsequent step. Specifically, 0.1 μm or more to 10 μm or less is preferred. The mold 4 employed may be formed of PMMA or PDMS (Polydimethylsiloxane), for example. As for the method of forming the ridges and grooves on the resist film 3, they may be formed by transfer of a roll-to-roll mode which uses roll-shaped metal molds instead of the mold 4.

As this time, if the resist film 3 is thermoplastic, the resist film 3 is heated beforehand to maintain it in a softened state, and the mold 4 is pressed thereon. Next, by separating the mold 4 from the resist film 3 after the resist film 3 is cooled, the ridges and grooves are formed on the resist film 3. If the resist film 3 is ultraviolet curable, ultraviolet light is emitted to the resist film 3 after pressing the mold 4 on the resist film 3. This emission of ultraviolet light hardens the resist film 3 and the ridges and grooves are formed on the resist film 3. A resist film sensitive to a wavelength of light other than ultraviolet light may be used as the resist film 3.

(Step S4) Etching

Since residual film 5 is formed in the grooves of the resist film 3 as shown in FIG. 6, etching is carried out to remove this residual film 5. The residual film 5 is removed by performing an etching process by oxygen reactive ion etching (RIE), for example. This exposes the insulating film 2 to the grooves of the resist film 3.

(Step S5) Lyophobizing Process

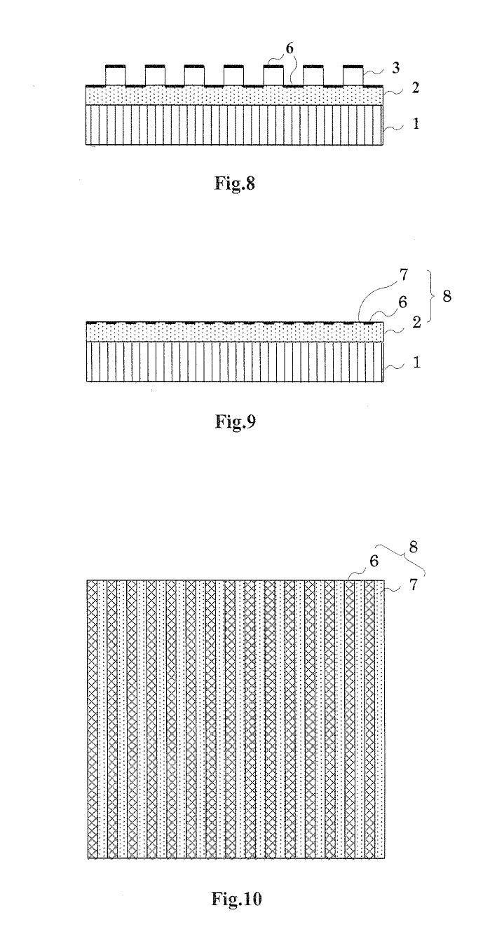

Next, as shown in FIG. 7, plasma treatment is carried out in a fluorine atmosphere (CF4, SF6 or the like) for the substrate 1 having undergone the etching process, which lyphobizes the surfaces of the resist film 3 and insulating film 2, as shown in FIG. 8. That is, the resist film 3 with the residual film removed therefrom serves as a mask in the lyophobizing process of the insulating film 2. Lyophobic here refers to being lyophobic with respect to droplets 9 ejected when forming wires by inkjet technique afterward.

(Step S6) Development

Next, in order to remove the resist film 3, a developing process is carried out. When PMMA is used as the resist film 3, acetone can be employed as developer. Since the resist film 3 is removed from the insulating film 2 as a result, a foundation pattern is formed as shown in FIG. 9, in which lyophobic portions 6 having been lyophobized and lyophilic portions 7 not having been lyophobized are formed substantially parallel and alternately on the insulating film 2. This foundation pattern corresponds to the first foundation pattern in this invention. The insulating film 2, and the lyophobic portions 6 and lyophilic portions 7 formed substantially parallel and alternately on the insulating film 2, constitute a foundation layer 8.

With the above, the foundation layer 8 can be formed to have the lyophobic portions 6 and lyophilic portions 7 formed on the insulating film 2. FIG. 10 is a front view of the foundation layer 8. The lyophobic portions 6 and lyophilic portions 7 are formed substantially parallel and alternately in vertical stripes. The lyophobic portions 6 are formed to have long sides and short sides in a ratio of 5:1 or more. Step S2-Step S6 correspond to the first foundation pattern forming step in this invention.

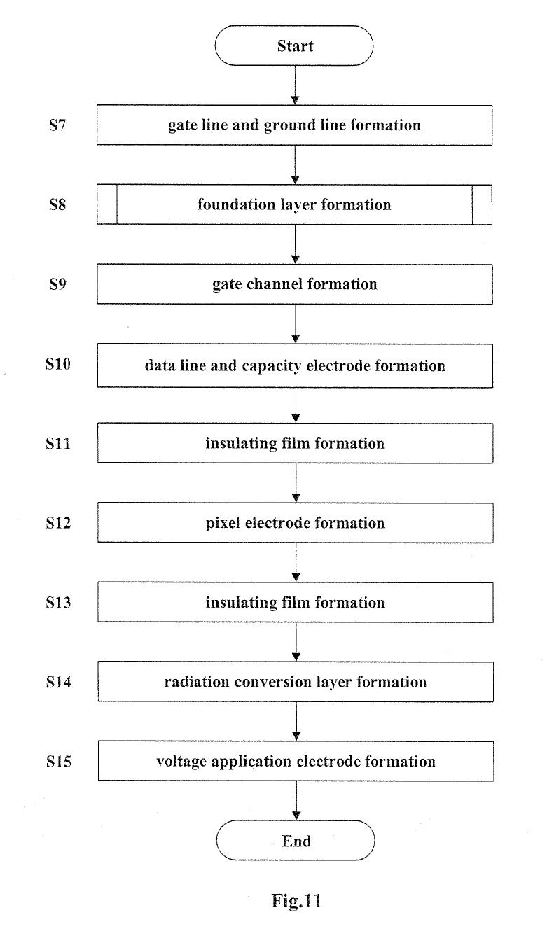

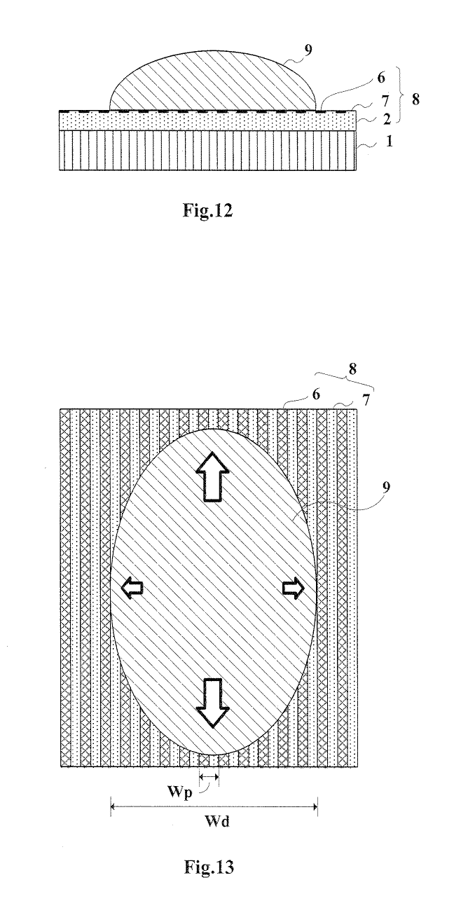

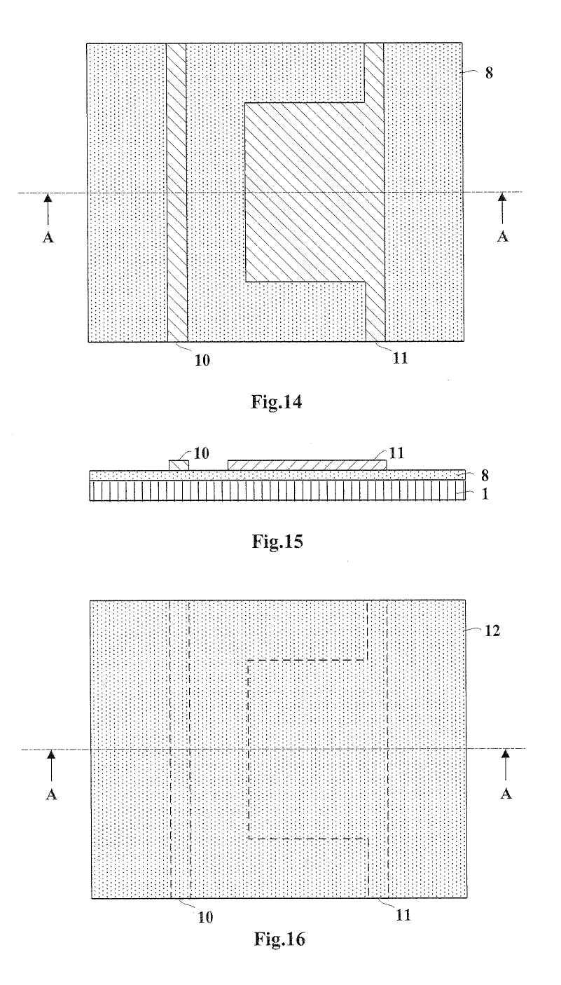

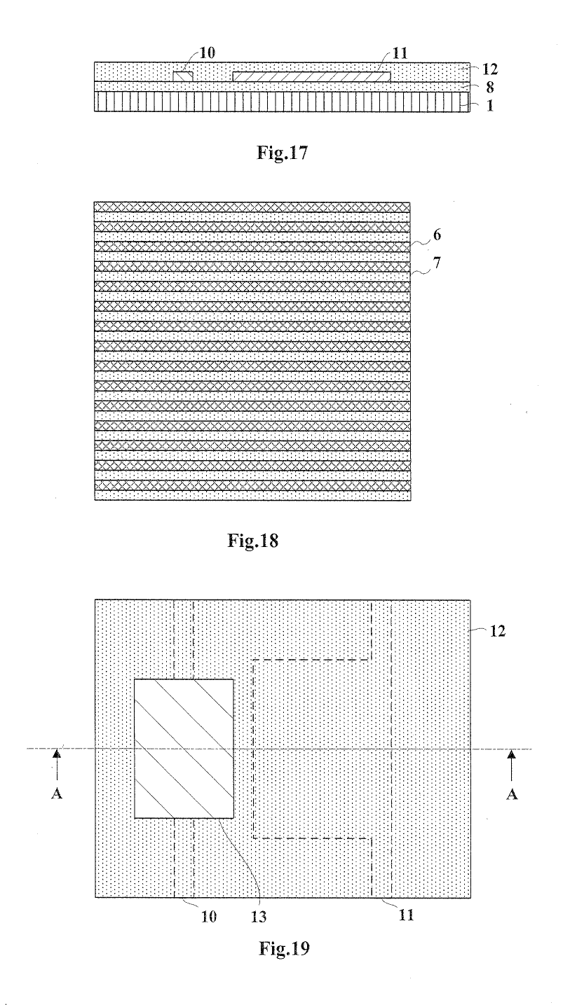

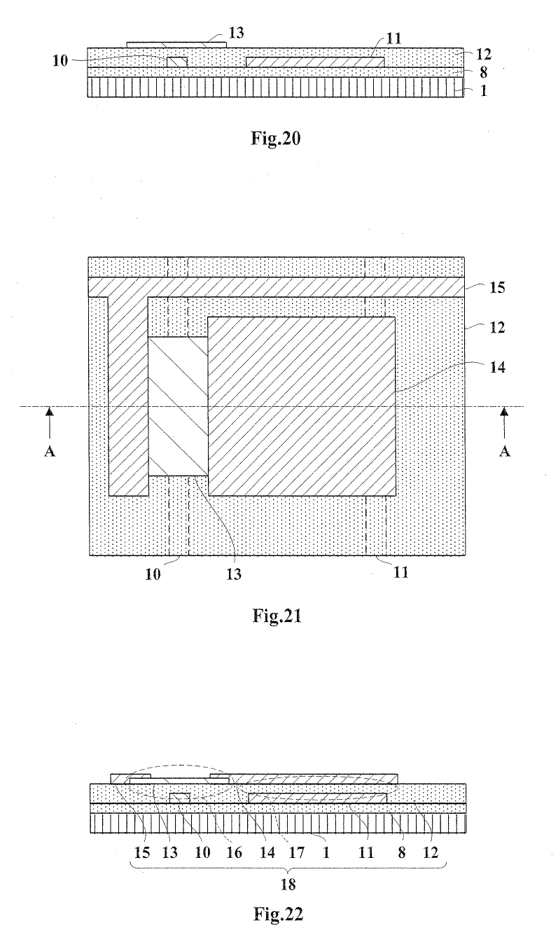

Next, a process of manufacturing the FPD by laminating wires and semiconductor layers on the substrate 1 with the foundation layer 8 formed thereon will be described. FIG. 11 is a flow chart showing a flow of the process of manufacturing the FPD according to Embodiment 1. FIG. 12 is a view in vertical section showing a droplet ejected onto the foundation layer according to Embodiment 1. FIG. 13 is a front view showing the droplet ejected onto the foundation layer according to Embodiment 1. FIGS. 14 through 28 are views showing the process of manufacturing the FPD according to Embodiment 1. FIG. 15 is a section taken on line A-A of FIG. 14. FIG. 17 is a section taken on line A-A of FIG. 16. FIG. 20 is a section taken on line A-A of FIG. 19. FIG. 22 is a section taken on line A-A of FIG. 21.

(Step S7) Gate Line and Ground Line Formation

As shown in FIGS. 12 and 13, the lyophobic portions 6 and lyophilic portions 7 are formed on the foundation layer 8 to have a pitch distance Wp which is 1/10 or less of width Wd of a droplet 9. When the droplet 9 is ejected by inkjet technique to the foundation layer 8 formed on the substrate 1, the droplet 9 straddles some lyophobic portions 6. Since end faces of the droplet 9 are repelled by edges of the lyophobic portions 6, extension of the droplet 9 is restricted in directions straddling the lyophobic portions 6. On the other hand, in directions along the long sides of the lyophobic portions 6, the droplet 9 extends over the surfaces of the lyophilic portions 7, which provides momentum to extend over the surfaces of the lyophobic portions 6 also. Consequently, the droplet 9 extends to follow the pattern of the lyophobic portions 6. Thus, the droplet 9 extends to follow the pattern of the lyophobic portions 6 (in the directions along the long sides of the lyophobic portions 6) more than in the directions straddling the lyophobic portions 6. For the above reason, gate lines 10 and ground lines 11 are formed to follow the pattern of the lyophobic portions 6 (in vertical directions in FIG. 13). As shown in FIGS. 14 and 15, a gate line 10 and a ground line 11 are formed by inkjet technique. The gate line 10 has a wire width of 1 μm to 100 μm. The droplets 9 correspond to the fluid in this invention. Step S7 corresponds to the first wire forming step in this invention.

(Step S8) Foundation Layer Formation

The foundation layer forming steps from step 1 to step 6 are executed again on the substrate 1 with the gate lines 10 and ground lines 11 formed thereon. Consequently, as shown in FIGS. 16 and 17, a foundation layer 12 is formed on the gate lines 10, ground lines 11 and foundation layer 8. It is preferred that the same material is used for the insulating film acting as the base of this foundation layer 12 and the insulating film 2 acting as the base of the foundation layer 8. This is because it is easier to plot wires with the same plotting conditions. Data lines 15 formed on this foundation layer 12 subsequently are formed in a direction intersecting the gate lines 10 and ground lines 11, and opposite across the foundation layer 12. For this reason, the pattern of the lyophobic portions 6 formed on the foundation layer 12 is formed in a direction (horizontal direction) intersecting the pattern of the lyophobic portions 6 of the foundation layer 8 as shown in FIG. 18. The insulating film acting as the base of the foundation layer 12 corresponds to the second insulating film in this invention. The foundation pattern formed on the foundation layer 12 corresponds to the second foundation pattern in this invention. Step S8 corresponds to the second insulating film forming step and second foundation pattern forming step in this invention.

(Step S9) Gate Channel Formation

Then, as shown in FIGS. 19 and 20, gate channels 13 are formed by laminating semiconductor film in predetermined positions opposed to the gate lines 10 across the foundation layer 12.

(Step S10) Data Line and Capacity Electrode Formation

As shown in FIGS. 21 and 22, capacity electrodes 14 and data lines 15 are laminated and formed on the foundation layer 12 as opposed to each other across the gate channels 13. The capacity electrodes 14 are laminated and formed to be opposed to the ground lines 11 across the foundation layer 12. Part of the gate lines 10 opposed to the gate channels 13, part of the data lines 15 adjacent the gate channels 13, the gate channels 13, part of the capacity electrodes 14 adjacent the gate channels 13, and the foundation layer 12 interposed between the gate lines 10, and the data lines 15, gate channels 13 and capacity electrodes 14 constitute thin-film transistors 16. Part of the capacity electrodes 14, part of the ground lines 11, and the foundation layer 12 interposed between the capacity electrodes 14 and the ground lines 11 constitute capacitors 17. Thus, an active matrix substrate 18 is formed to include the substrate 1, capacity electrodes 14, capacitors 17, thin-film transistors 16, gate channels 13, data lines 15, gate lines 10, ground lines 11, foundation layer 8 and foundation layer 12. Step S10 corresponds to the second wire forming step in this invention.

(Step S11) Insulating Film Formation

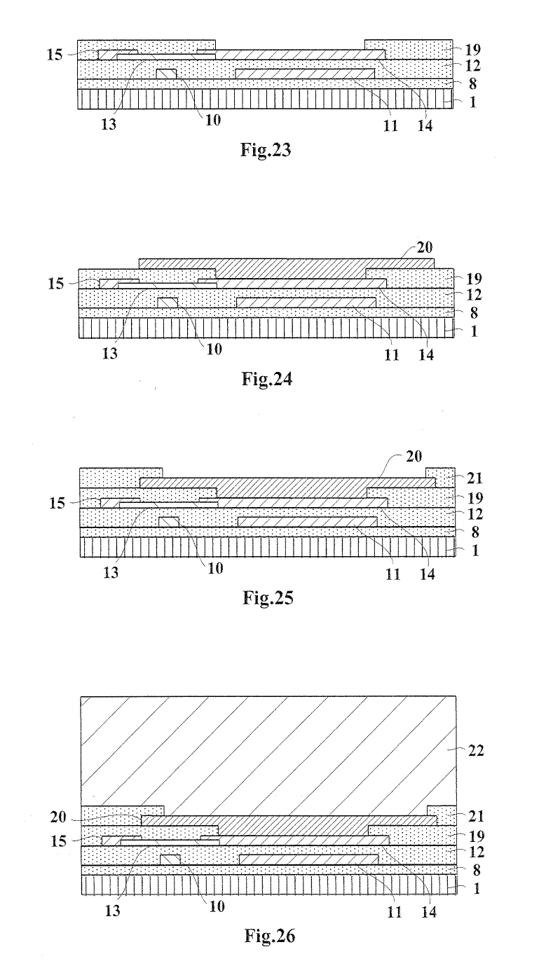

As shown in FIG. 23, an insulating film 19 is laminated and formed on the data lines 15, capacity electrodes 14, gate channels 13 and foundation layer 12. In order to connect to pixel electrodes 20 to be laminated subsequently the insulating film 19 is not laminated and formed on parts of the capacity electrodes 14. The insulating film 19 is laminated and formed around the capacity electrodes 14.

(Step S12) Pixel Electrode Formation

As shown in FIG. 24, the pixel electrodes 20 are laminated on the capacity electrodes 14 and insulating film 19. This electrically connects the pixel electrodes 20 and capacity electrodes 14.

(Step S13) Insulating Film Formation

As shown in FIG. 25, an insulating film 21 is laminated on the pixel electrodes 20 and insulating film 19. In order for the pixel electrodes 20 to collect carriers generated by a semiconductor layer 22 to be laminated subsequently, the insulating film 21 is not laminated and formed on large parts of the pixel electrodes 20 to secure direct contact with the semiconductor layer 22. The insulating film 21 is laminated and formed only around the pixel electrodes 20. That is, the insulating film 21 is laminated and formed to leave open large parts of the pixel electrodes 20.

(Step S14) Radiation Conversion Layer Formation

As shown in FIG. 26, a semiconductor layer 22 is laminated and formed as radiation conversion layer on the pixel electrodes 20 and insulating film 21. In the case of Embodiment 1, vacuum deposition is used since amorphous selenium (a-Se) is laminated as the semiconductor layer 22 which is a light receiving element. The laminating method may be changed according to the type of semiconductor used for the semiconductor layer 22.

(Step S15) Voltage Application Electrode Formation

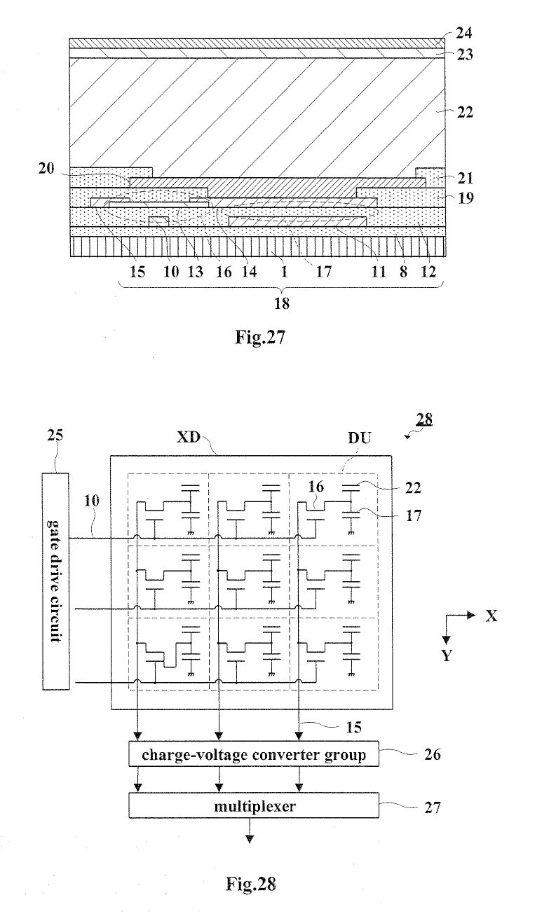

As shown in FIG. 27, a voltage application electrode 23 is laminated and formed on the semiconductor layer 22. Subsequently, a protective layer 24 is further laminated and formed on the voltage application electrode 23. As shown in FIG. 28, peripheral circuits such as a gate drive circuit 25, a charge-voltage converter group 26 and a multiplexer 27 are provided to complete a manufacturing series of the FPD 28.

Formation of the laminated patterns of the active matrix substrate 18 is not limited to the manufacturing method according to the foregoing embodiment, but vacuum deposition, spin coat technique, electroplating, sputtering, photolithography and so on may be combined.

<Flat Panel X-ray Detector>

As shown in FIGS. 27 and 28, the FPD 28 manufactured as described above includes an X-ray detecting unit XD which receives X-rays and has X-ray detecting elements DU arranged in XY directions, in a two-dimensional matrix form. The X-ray detecting elements DU are operable in response to incident X-rays, and output charge signals on a pixel-by-pixel basis. For convenience of description, FIG. 28 shows the X-ray detecting elements DU in a two-dimensional matrix arrangement for 3×3 pixels. In the actual X-ray detecting unit XD, the X-ray detecting elements DU are in a matrix arrangement for 4096×4096 pixels, for example, to match the number of pixels of the FPD 27. The X-ray detecting elements DU correspond to the elements relating to light in this invention.

As shown in FIG. 27, the X-ray detecting elements DU have, formed under the voltage application electrode 23 to which a bias voltage is applied, the semiconductor layer 22 which generates carriers (electron-hole pairs) in response to incident X-ray. And the pixel electrodes 20 are formed under the semiconductor layer 22 for collecting the carriers on a pixel-by-pixel basis. Further, the active matrix substrate 18 is formed, which includes the capacitors 17 for storing electric charges generated by the carriers collected by the pixel electrodes 20, the thin-film transistors 16 and ground lines 11 electrically connected to the capacitors 17, the gate lines 10 for sending signals of switching action to the thin-film transistors 16, the data lines 15 for reading the electric charges from the capacitors 17 through the thin-film transistors 16 as X-ray detection signals, and the substrate 1 which supports these. With this active matrix substrate 18, X-ray detection signals can be read out, on a pixel-by-pixel basis, from the carriers generated in the semiconductor layer 22.

The semiconductor layer 22 consists of an X-ray sensitive semiconductor, which is formed of non-crystalline, amorphous selenium (a-Se) film, for example. It has a construction (direct conversion type) which, when X-rays fall on the semiconductor layer 22, directly generates a given number of carriers proportional to the energy of these X-rays. Especially this a-Se film can easily provide an enlarged detection area. The semiconductor layer 22 may be a semiconductor film other than the above, such as a polycrystalline semiconductor film, for example.

Thus, the FPD 28 in this embodiment is a flat panel X-ray sensor of two-dimensional array construction with the numerous X-ray detecting elements DU which are X-ray detection pixels arranged along the X- and Y-directions. Each X-ray detecting element DU can carry out local X-ray detection, which enables a two-dimensional distribution measurement of X-ray intensity.

X-ray detecting operation by the FPD 28 in this embodiment is as follows.

That is, when X-rays are emitted to a subject to carry out X-ray imaging, a radiological image transmitted through the subject is projected to the a-Se film, and carriers proportional to density variations of the image are generated in the a-Se film. The generated carriers are collected by the pixel electrodes 20 due to an electric field produced by the bias voltage. Electric charges corresponding to the number of carriers generated are induced by and stored for a predetermined time in the capacitors 17. Subsequently, a gate voltage sent through the gate lines 10 from the gate drive circuit 25 causes the thin-film transistors 16 to take switching action. This outputs the charges stored in the capacitors 17 via the thin-film transistors 16 and through the data lines 15 to be converted into voltage signals by the electric charge-voltage converter group 26, and read out in order as X-ray detection signals by the multiplexer 27.

An electric conductor which forms the data lines 15, gate lines 10, ground lines 11, pixel electrodes 20, capacity electrodes 14 and voltage application electrode 23 in the above FPD 28 may be printed and formed, as the droplets 9 of metal ink produced by making a metal such as silver, gold, copper or the like into paste form. An organic ink of high conductivity represented by polyethylene dioxythiophene doped with polystyrene sulfonate (PEDOT/PSS), or ITO ink may be printed and formed as the droplets 9.

The semiconductor which forms the gate channels 13 may be an organic semiconductor consisting of an organic substance such as pentacene, or may be an inorganic semiconductor such as an oxide semiconductor represented by low-temperature polysilicon or zinc oxide (ZnO).

In the foregoing embodiment, the semiconductor layer 22 generates carriers in response to X-rays, but X-rays are not limitative. It is possible to use a radiation conversion layer sensitive to radiation such as gamma rays, or a light conversion layer sensitive to light. A photodiode may be used instead of the light conversion layer. Then, a radiation detector and a photodetector, although the same in structure, can be manufactured.

The method of manufacturing the optical matrix device constructed as described above forms the foundation layer 8 with the lyophilic portions 7 and lyophobic portions 6 formed substantially parallel thereon. Therefore, when the gate lines 10, ground lines 11 and data lines 15 are formed on the foundation layer 8 using droplets 9 ejected by inkjet technique, the droplets 9 will extend along the pattern of the lyophobic portions 6, with extension restricted in the directions of the short sides of the lyophobic portions 6, thereby improving the plotting accuracy of each wire. The ejected droplets 9 do not spread isotropically, but spread linearly along the pattern of the lyophobic portions 6. Consequently, since the droplets 9 having landed on the foundation layer 8 do not flow sideways, there is no possibility of contact between adjacent printed wiring patterns. As a result, short-circuiting defects between the wiring patterns decrease, to improve the yield of the active matrix substrate 18 formed of the printed wiring patterns.

Since the droplets 9 landed on the foundation layer 8 and foundation layer 12 do not flow sideways, the widths of wires of the gate lines 10, ground lines 11 and data lines 15 do not become larger than design values. Consequently, since parasitic capacitance between wires which intersect across the foundation layer 12 is reduced, the charge signals can be read at high speed from the capacitors 17, to improve refresh rate.

With this foundation layer 8, even when changing a wire width, a wiring pattern of different wire width can be formed on the already formed foundation pattern. Also when a wiring pattern of different pattern pitch is formed, since the pitch distance between the lyophobic portions 6 and lyophilic portions 7 is a length one tenth or less of the droplets 9 ejected, wires can be formed regardless of the pattern of the lyophobic portions 6, as long as it follows the direction of the long sides of the lyophobic portion 6. That is, the wire width and wiring pattern pitch can be changed on demand. Since the lyophobic portions 6 have only surface molecules lyophobized to a certain degree, the lyophobic portions 6 are not inserted as insulators into the wires applied to the surfaces of the lyophobic portions 6, and noise by capacitor effect hardly occurs.

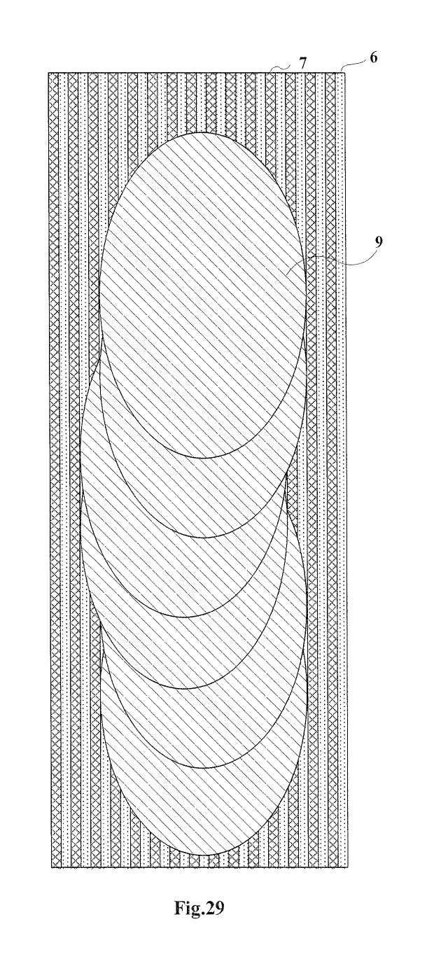

Even if the droplets 9 are ejected as shifted in the directions of the short sides of the lyophobic portions 7 as shown in FIG. 29, since extension of the droplets 9 is restricted in the directions of the short sides of the lyophobic portions 7, the shifting of wire width formed can be limited to 1/10 of the wire width.

### Embodiment 2

While Embodiment 1 described above employs a lyophilic one or a lyophilized one as the insulating film 2, a lyophobic insulating film may be employed as Embodiment 2 of this invention. In this case, a process is carried out to make a lyophobic insulating film 2 lyophilic by using the resist film 3 as a mask. As an example of making the insulating film 2 lyophilic, plasma treatment (oxygen plasma treatment) which uses oxygen in the atmospheric may be cited. The lyophilizing treatment may be carried out by methods other than this.

By treating part of the surface of the lyophobic insulating film 2 to be lyophilic with respect to the droplets 9 in this way, a foundation pattern can be formed with lyophilic portions 7 and lyophobic portions 6 formed substantially parallel. That is, since the same foundation pattern as in FIG. 10 can be formed, the droplets 9 ejected by inkjet technique will extend on the surfaces of the lyophilic portions 7 and also on the surfaces of the lyophobic portions 6, along the direction of the long sides of the lyophobic portions 6, but with extension restricted in the directions of the short sides of the lyophobic portions 6. When wires are formed substantially parallel to the direction of the long sides of the lyophobic portions 6 on such a foundation pattern, since the direction of formation of the wires is the same as the direction of extension of the fluid, a uniform wire width can be formed. The other aspects of the embodiment are the same as those of Embodiment 1, and will not be described.

### Embodiment 3

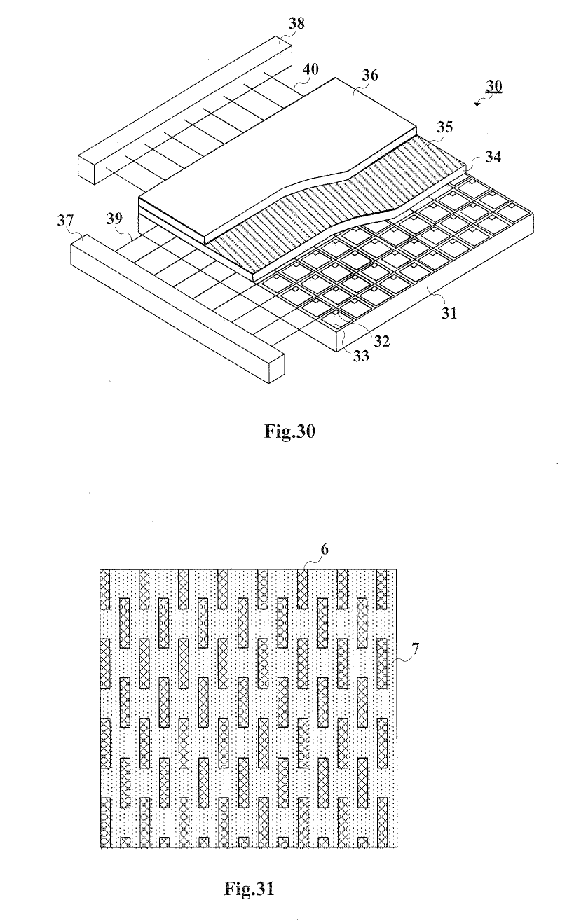

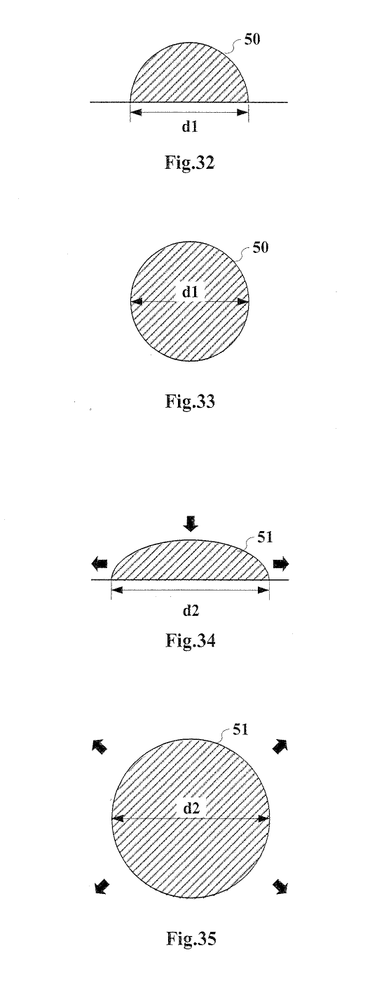

Next, Embodiment 3 of this invention will be described with reference to FIG. 30. FIG. 30 is a partly broken away perspective view of a display (organic EL display) having an active matrix substrate, as an example of image display device.

It is desirable that the method of this invention is applied also to manufacture of image display devices. As image display devices, a thin electroluminate display and a liquid crystal display can be cited. An image display device also has pixel circuits formed in the active matrix substrate, and application to such a device is desirable.

As shown in FIG. 30, an organic EL display having an active matrix substrate includes a substrate 31, an organic EL layer 34, a transparent electrode 35 and a protective film 36 successively laminated on the substrate 31 and connected to a plurality of TFT circuits 32 and pixel electrodes 33 arranged in a matrix form on the substrate 31, and a plurality of source electrode lines 39 and gate electrode lines 40 connecting each TFT circuit 32, a source drive circuit 37 and a gate drive circuit 38, respectively. Here, the organic EL layer 34 is formed by laminating respective layers such as an electron transport layer, a luminous layer and a hole transport layer. In the organic EL display 30, a foundation layer of the source electrode lines 39 and gate electrode lines 40 on the active matrix substrate is formed by the method of manufacturing the optical matrix device in Embodiment 1 described hereinbefore, and thus no possibility of contact between adjacent wires. Consequently, the image display device which can suppress short-circuiting between wires can De manufactured.

The above image display device is a display which uses display elements such as organic EL, but without being limited thereto, it may be a liquid crystal display having liquid crystal display elements. With the liquid crystal display, pixels are colored RGB by color filters. It may be a display having other display elements.

This invention is not limited to the foregoing embodiments, but may be modified as follows.

(1) In the foregoing embodiments, the foundation patterns of lyophobic portions 6 and lyophilic portions 7 are formed alternately and linearly on the insulating film. As shown in FIG. 31, for example, the lyophobic portions 6 may be formed in a staggered arrangement. With this method, when forming ridges and grooves on the resist film 3 using the nano imprint technique, even when forming them by step and repeat, it is easy to form a pattern of lyophobic portions 6 because the pattern of lyophobic portions 6 need not be a completely continuous pattern. The ratio between the long side and short side of the lyophobic portions 6 at this time, preferably, is 5:1 or more. If the ratio between the long side and short side of the lyophobic portions 6 is 5:1 or more, the applied droplets can easily extend in the direction of the long sides of the lyophobic portions 6.

(2) In the foregoing embodiments, the lyophobic portions 6 are formed by using, as mask, the resist film 3 with the ridges and grooves prepared by nano imprint technique. Instead of being limited to this method, a different photolithographic technique may be employed to form the lyophobic portions 6.

(3) In the foregoing embodiments, the insulating film 2 is formed of the synthetic resin. Instead of being limited to this, titanium oxide may be employed. When titanium oxide is irradiated with ultraviolet rays, irradiated portions will be lyophobized. Consequently, a pattern of lyophobic portions 6 and lyophilic portions 7 can be formed by irradiating titanium oxide with ultraviolet rays, using the resist film 3 as a mask.

(4) In the foregoing embodiments, ink jet printing is employed as the printing technique. However, wires may be formed by gravure printing or flexography.

(5) In the foregoing embodiments, the optical matrix device having the active matrix substrate is manufactured. However, an optical matrix device having a passive matrix substrate may be manufactured.

1. A method of manufacturing an optical matrix device for manufacturing, by a printing technique of applying a fluid, the optical matrix device constructed with elements relating to light arranged in a two-dimensional matrix form, the method comprising:
a first insulating film forming step for forming a first insulating film on a surface of a substrate of the optical matrix device;
a first foundation pattern forming step for forming a first foundation pattern with lyophilic portions and lyophobic portions formed substantially parallel thereon, by treating part of a surface of the first insulating film to be lyophobic with respect to the fluid; and
a first wire forming step for forming wires by applying the fluid to be substantially parallel to a direction of long sides of the lyophobic portions on the first foundation pattern, and to straddle a plurality of the lyophobic portions.

2. The method of manufacturing the optical matrix device according to claim 1, wherein a pitch distance provided by adjacent ones of the lyophobic portions and the lyophilic portions is formed to be one tenth or less of a width of the fluid applied in the first wiring step.

3. The method of manufacturing the optical matrix device according to claim 1, wherein a mask formed by nano imprint technique is used in forming the first foundation pattern.

4. The method of manufacturing the optical matrix device according to claim 1, wherein part of the surface of the first insulating film is treated by fluorine plasma to be lyophobic with respect to the fluid.

5. The method of manufacturing the optical matrix device according to claim 1, wherein an entire surface of the first insulating film is treated to be lyophilic before part of the surface of the first insulating film is treated to be lyophobic with respect to the fluid.

6. The method of manufacturing the optical matrix device according to claim 1, comprising:
a second insulating film forming step for forming a second insulating film on surfaces of the first wires and the first insulating film;
a second foundation pattern forming step for forming a second foundation pattern with lyophilic portions and lyophobic portions formed substantially parallel thereon, by treating part of a surface of the second insulating film to be lyophobic with respect to the fluid; and
a second wire forming step for forming further wires by applying the fluid to be substantially parallel to a direction of long sides of the lyophobic portions on the second foundation pattern, and to straddle a plurality of the lyophobic portions.

7. The method of manufacturing the optical matrix device according to claim 6, wherein the second foundation pattern is formed in a direction intersecting the first foundation pattern.

8. The method of manufacturing the optical matrix device according to claim 1, wherein the lyophobic portions are formed to have long sides and short sides in a ratio of 5:1 or more.

9. The method of manufacturing the optical matrix device according to claim 8, wherein the lyophobic portions are formed in a staggered arrangement.

10. The method of manufacturing the optical matrix device according to claim 1, wherein the printing technique is an inkjet technique.

11. A method of manufacturing, by a printing technique of applying a fluid, an optical matrix device constructed with elements relating to light arranged in a two-dimensional matrix form, the method comprising:
a first insulating film forming step for forming a first insulating film on a surface of a substrate of the optical matrix device;
a first foundation layer forming step for forming a first foundation layer with lyophilic portions and lyophobic portions formed substantially parallel thereon, by treating part of a surface of the first insulating film to be lyophilic with respect to the fluid; and
a first wire forming step for forming wires by applying the fluid to be substantially parallel to a direction of long sides of the lyophobic portions on the foundation layer, and to straddle a plurality of the lyophobic portions.

12. The method of manufacturing the optical matrix device according to claim 1, wherein the optical matrix device is a photodetector.

13. The method of manufacturing the optical matrix device according to claim 12, wherein the optical matrix device is a radiation detector.

14. The method of manufacturing the optical matrix device according to claim 1, wherein the optical matrix device is an image display device.

15. The method of manufacturing the optical matrix device according to claim 11, wherein the optical matrix device is a photodetector.

16. The method of manufacturing the optical matrix device according to claim 15, wherein the optical matrix device is a radiation detector.

17. The method of manufacturing the optical matrix device according to claim 11, wherein the optical matrix device is an image display device.
